(19) United States
(12) Patent Application Publication
(10) Pub. No.: US 2025/0368895 A1
(43) Pub. Date: Dec. 4, 2025

(54) HIGH TEMPERATURE CORROSION INHIBITOR FORMULATION

(71) Applicants: Saudi Arabian Oil Company, Dhahran (SA); King Fahd University of Petroleum & Minerals, Dhahran (SA)

(72) Inventors: Ime Bassey Obot, Dhahran (SA); Ahmad A. Sorour, Dhahran (SA); Tao Chen, Dhahran (SA); Qiwei Wang, Dhahran (SA); Norah Abdullah Aljeaban, Al Khobar (SA); Fahd Ibrahim AlGhunaimi, Dhahran (SA)

(21) Appl. No.: 18/733,007

(22) Filed: Jun. 4, 2024

(51) Int. Cl. C09K 15/30; C23F 11/14

(52) U.S. Cl. CPC C09K 15/30; C23F 11/149

(57) ABSTRACT

A corrosion inhibitor composition includes a fatty acid ethoxylate, a thiourea, an arylthiourea, a thiazole, and two or more solvents. A metal article in contact with the composition has a corrosion rate of about 25 to about 45 mils penetration per year (mpy), as determined by an ASTM G111 standard test method. A method for inhibiting corrosion of a metal in contact with a corrosive fluid.

### TECHNICAL FIELD

The present disclosure relates to a corrosion inhibitor composition and, more particularly, to a high temperature corrosion inhibitor composition for oil and gas drilling. The present disclosure also provides a method for inhibiting corrosion of a metal used in the oil and gas industry using the composition.

### BACKGROUND

The application of long-chain polar compounds as corrosion inhibitors in oil and gas wells enables the continued operation of wells that would otherwise have been abandoned due to corrosivity and excessive water production alongside hydrocarbons. Commonly used inhibitor compositions to control sweet corrosion in oil and gas wells include nitrogen-containing compounds such as amines, imidazolines, amides, and quaternary ammonium salts, combined with alkoxylated phosphate esters, intensifiers, and surfactants. However, these inhibitor compositions are only effective at temperatures below 100° C., limiting their applications in deep drilling and aggressive downhole conditions.

Compositions containing para-(9-(2-methylisoxazolidin-5-yl) nonyloxy) benzaldehyde-based compounds and formulations containing amides, organic alkynol, mercaptans acid, piperidine, and mercaptopyridine have been tested against steel corrosion. However, none of them demonstrate the capability of maintaining efficacy in inhibiting low carbon steel corrosion above 100° C., which is required for deep oil and gas wells operations with high temperature, high pressures, and high total dissolved solids (TDS).

Accordingly, there is a need to develop high temperature high pressure (HTHP), environmentally friendly, non-toxic corrosion inhibitor compositions for corrosion mitigation in the oil and gas industry.

### SUMMARY

In an exemplary embodiment, a corrosion inhibitor composition is disclosed. The composition contains a fatty acid ethoxylate, a thiourea, an arylthiourea, a thiazole, and two or more solvents.

In some embodiments, the fatty acid ethoxylate is a compound of formula (I)

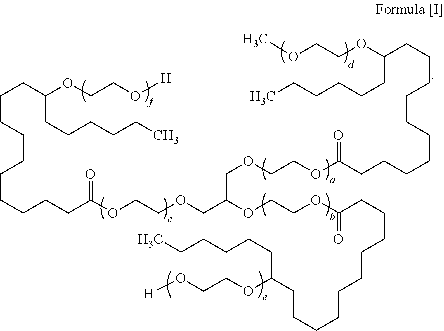

In some embodiments, each of a, b, c, d, e, and f is an integer of from 1 to 20.

In some embodiments, 5<a+b+c+d+e+f<60.

In some embodiments, the fatty acid ethoxylate is present in the composition in an amount of about 0.5 to about 20 wt. % of the composition.

In some embodiments, the thiourea is a compound of formula (II)

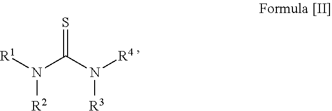

in which R¹, R², R³, and R⁴ are each independently selected from the group consisting of a hydrogen atom, a hydroxyl group, a halogen atom, an optionally substituted alkyl, and an optionally substituted cycloalkyl.

In some embodiments, the thiourea is present in the composition in an amount of about 0.01 to about 10 wt. % of the composition.

In some embodiments, the arylthiourea is a compound of formula (III)

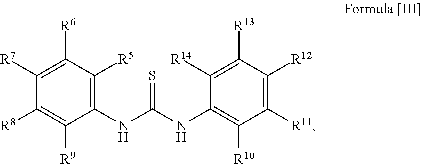

in which R⁵ to R¹⁴ are each independently selected from the group consisting of a hydrogen atom, a halogen atom, a hydroxyl group, an amine group, an optionally substituted alkyl, an optionally substituted alkoxy, and an optionally substituted alkoxyalkyl.

In some embodiments, the arylthiourea is present in the composition in an amount of 0.01 to 10 wt. % of the composition. In some embodiments, the thiazole is a compound of formula (IV)

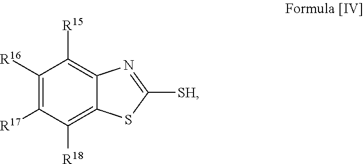

in which R¹⁵, R¹⁶, R¹⁷, and R¹⁸ are each independently selected from the group consisting of a hydrogen atom, a halogen atom, a hydroxyl group, an amine group, a cyano group, a nitro, a nitrile, an optionally substituted alkyl, and an optionally substituted alkoxy.

In some embodiments, the thiazole is present in the composition in an amount of about 0.1 to about 10 wt. % of the composition.

In some embodiments, the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof.

In some embodiments, the two or more solvents comprise dimethyl sulfoxide (DMSO) and glycol.

In some embodiments, the DMSO is present in the composition in an amount of about 20 to about 70 wt. % of the composition.

In some embodiments, the glycol is present in the composition in an amount of about 20 to about 70 wt. % of the composition.

In some embodiments, the composition contains about 1 to about 15 wt. % of the fatty acid ethoxylate, about 0.1 to about 10 wt. % of the thiourea, about 0.1 to about 10 wt. % of the diphenyl thiourea, about 0.1 to about 10 wt. % of the benzo[d]thiazole-2-thiol, about 40 to about 50 wt. % of the DMSO, and about 35 to about 40 wt. % of the glycol.

In some embodiments, a metal article in contact with the composition has a corrosion rate in a range of about 25 to about 45 mils penetration per year (mpy), as determined by an ASTM G111 standard test method.

In an exemplary embodiment, a method for inhibiting corrosion of a metal in contact with a corrosive fluid is also disclosed. The method includes adding to the corrosive fluid the corrosion inhibitor composition in an amount of about 5 to about 15,000 ppm based on a total number of parts by weight of the corrosive fluid at a temperature of about 70 to about 150 degrees Celsius (° C.).

In some embodiments, the corrosive fluid comprises carbon dioxide in an amount of at least 0.1 grams (g) carbon dioxide per kilogram (kg) of the corrosive fluid.

In some embodiments, the corrosive fluid comprises an alkali metal halide salt.

In some embodiments, the alkali metal halide salt comprises sodium chloride (NaCl), calcium chloride (CaCl₂), potassium chloride (KCl), magnesium chloride (MgCl₂), strontium chloride (SrCl₂), barium sulfate (BaSO₄), hydrates thereof, or mixtures thereof.

In some embodiments, the metal is a steel.

In some embodiments, the steel is a carbon steel.

In some embodiments, the composition is present in the corrosive fluid in an amount of about 500 ppm, and the method has an inhibition efficiency of about 80 to about 95% when the metal is in contact with the corrosive fluid at a temperature of about 120° C. under a pressure of about 100 pounds per square inch (psi) by following the ASTM G111 standard test method.

### BRIEF DESCRIPTION OF THE DRAWINGS

FIG. 1 is a diagrammatic illustration depicting the setup of a stirred autoclave used for the high temperature high pressure (HTHP) autoclave corrosion test, according to certain embodiments of the present disclosure.

FIG. 2 is a plotted graph illustrating effects of the corrosion inhibitor composition on a C1018 steel coupon in a CO₂-saturated water brine (synthetic brine) solution according to certain embodiments of the present disclosure.

FIG. 3A is an image of the C1018 steel coupons before the HTHP autoclave corrosion test, according to certain embodiments of the present disclosure.

FIG. 3B is an image of the C1018 steel coupons after the HTHP autoclave corrosion test, according to certain embodiments of the present disclosure.

FIG. 3C is an image of the C1018 steel coupons obtained from the HTHP autoclave corrosion test after cleaning, according to certain embodiments of the present disclosure.

FIG. 4A illustrates optical images and a depth profile of the C1018 steel coupons obtained after the HTHP autoclave corrosion test in the absence of the corrosion inhibitor composition, according to certain embodiments of the present disclosure.

FIG. 4B illustrates optical images and a depth profile of the C1018 steel coupons obtained after the HTHP autoclave corrosion test in the presence of the corrosion inhibitor composition, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the term “corrosion” refers to material that decomposes because a chemical reaction occurs with its surrounding environment, such as a corrosive fluid having an acidic, neutral, or alkaline pH. There are two main types of corrosion: general or uniform attack corrosion and galvanic corrosion. Typical or uniform corrosion happens, for instance, when the material, such as a metal, is in a humid environment, creating metal oxide and corroding.

As used herein, “inhibition efficiency” is a measure of effectiveness in inhibiting the corrosion of the metal article when in contact with the corrosive medium.

As used herein, a “corrosive fluid” is a material that attacks and damages the surface it encounters. In the present disclosure, the corrosive fluid may be a CO₂-saturated water brine (synthetic brine) solution.

As used herein, the term “corrosion inhibitor” refers to a chemical compound that, when added to a liquid or gas, decreases the corrosion rate of a material, typically a metal or an alloy, that meets the fluid. The effectiveness of a corrosion inhibitor may depend on fluid composition, quantity of water, and flow regime.

As used herein, the term “fatty” describes a compound with a long-chain (linear) hydrophobic portion made up of hydrogen and anywhere from 6 to 26, such as 8 to 24, 10 to 22, 12 to 20, or 14 to 18 carbon atoms, which may be fully saturated or partially unsaturated, and optionally attached to a polar functional group such as a hydroxyl group, an amine group, or a carboxyl group (e.g., carboxylic acid). Fatty alcohols, fatty amines, fatty acids, fatty esters, and fatty amides are examples of materials which contain a fatty portion, and are thus considered “fatty” compounds herein. For example, stearic acid, which has 18 carbons total (a fatty portion with 17 carbon atoms and 1 carbon atom from the —COOH group), is considered to be a fatty acid having 18 carbon atoms herein as described in formula (I).

As used herein, the term “natural oil” refers to an edible vegetable oil derived from natural sources and includes, but is not limited to, coconut oil, palm oil, soybean oil, corn oil canola (rapeseed) oil, peanut oil, safflower oil, and cotton seed sunflower oil. The natural oils may be optionally hydrogenated.

As used herein, the terms “halogen,” or “halogen atom” refer to fluorine, chlorine, bromine and iodine.

As used herein, the term “substituted” refers to at least one hydrogen atom that is replaced with a non-hydrogen group, provided that normal valences are maintained and that the substitution results in a stable compound.

When a substituent is noted as “optionally substituted,” the substituents are selected from the group including, but not limited to, halo, hydroxyl, alkoxy, oxo, alkanoyl, aryloxy, alkanoyloxy, amino, alkylamino, arylamino, arylalkylamino, disubstituted amines (e.g., in which the two amino substituents are selected from the group including, but not limited to, alkyl, aryl or arylalkyl), alkanylamino, aroylamino, aralkanoylamino, substituted alkanoylamino, substituted arylamino, aubstituted aralkanoylamino, thiol, alkylthio, damantly, arylalkylthio, alkylthiono, arylthiono, aryalkylthiono, alkylsulfonyl, arylsulfonyl, arylalkylsulfonyl, sulfonamide (e.g., —SO₂NH₂), substituted sulfonamide, nitro, cyano, carboxy, carbamyl (e.g., —CONH₂), substituted carbamyl (e.g., —CONHalkyl, —CONHaryl, —CONHarylalkyl or cases where there are two substituents on one nitrogen from alkyl, aryl, or alkylalkyl), alkoxycarbonyl, aryl, substituted aryl, guanidine, heterocyclyl (e.g., indolyl, imidazoyl, furyl, thienyl, thiazolyl, pyrrolidyl, pyridyl, pyrimidiyl, pyrrolidinyl, piperidinyl, morpholinyl, piperazinyl, and homopiperazinyl), substituted heterocyclyl and combinations thereof. The substituents may be optionally substituted and may be either unprotected or protected as necessary, as known to those skilled in the art.

As used herein, the term “alkyl” refers to linear or branched aliphatic hydrocarbon chains of 1 to 20 carbon atoms. The alkyl group includes, but is not limited to, C1 to C6 alkyl, or C1 to C4 alkyl, or C1 to C3 alkyl, or C1 to C2 alkyl. Non-limiting examples of such alkyl group include, but are not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, and 2,3-dimethylbutyl.

As used herein, the term “cycloalkyl” refers to a univalent radical formed by removing one hydrogen atom from a cycloalkane. The cycloalkyl group as used herein may contain up to 8 carbon atoms. Non-limiting examples of such cyclic hydrocarbon (e.g., cycloalkyl) groups include, but are not limited to, cyclopropyl, cyclobutyl, cyclopentyl, cyclohexyl, norbornyl, and damantly. Branched cycloalkyl groups, such as 1-methylcyclopropyl and 2-methycyclopropyl groups, are included in the definition of cycloalkyl as used in the present disclosure.

As used herein, the terms “rough surface,” or “rough surface morphology” refer to the physical characteristics or features of a surface that deviate from smoothness or regularity. The term “rough surface morphology” may include unevenness, irregularities, and variations in height, shape, or texture of a surface at a micro or macro scale. In the present disclosure, the rough surface morphology of the metal coupon surface includes, but is not limited to, bumps, ridges, valleys, peaks, or irregular shapes that may be randomly distributed or organized in a specific pattern.

Additionally, the surface roughness may be determined by roughness average (Ra), root mean square (RMS) roughness, or peak-to-valley height. Roughness average (Ra) is calculated by averaging the surface roughness of at least about 5, representative locations spaced approximately evenly across the portion of the metal coupon surface. In some embodiments, the thickness is measured at representative points across the longest dimension of the portion of the metal coupon surface. The standard deviation of roughness is found by calculating the standard deviation of the local average roughness across at least about 5 representative locations spaced approximately evenly across the portion of the polyamide layer. Arithmetic average roughness (Sa) is the areal (3D) equivalent of two-dimensional Ra. Sa refers to the average height of all measured points in the areal measurement. The roughness refers to surface micro-roughness which may be different than measurements of large-scale surface variations. In some embodiments, this is measured using atomic force microscopy (AFM).

As used herein, the terms “smooth surface” or “smooth surface morphology” refer to the roughness average (Ra) value of the metal coupon measured after the HTHP autoclave corrosion test has a difference of less than about 50%, such as less than about 30%, less than about 20%, less than about 10%, or less than about 5%, compared to a Ra value of the metal coupon measured before the HTHP autoclave corrosion test.

In view of the forgoing, one objective of the present disclosure is to describe a corrosion inhibitor composition. A further objective of the present disclosure is to provide methods for inhibiting corrosion of a metal in contact with a corrosive fluid containing the corrosion inhibitor composition.

Provided in the present disclosure is a composition for inhibiting corrosion in gas wells. The corrosion inhibitor composition of the present disclosure is effective in preventing or reducing the corrosion rate of metals that are in contact with a corrosive fluid, particularly under high temperatures, high pressures, and high total dissolved solids, typically encountered in the oil and gas industries. In some embodiments, the metal is iron, zinc, steel, or any combination thereof. In some embodiments, the steel is carbon steel or low carbon steel. The composition of the present disclosure is cost effective and capable of maintaining its efficacy at a temperature of above 100° C. for an extended period, alone or in combination with other formulations. Suitable examples of formulations include, but are not limited to, hydroxamic acids, benzothiazole, quinoxaline, imidazole, benzothiazine, chitosan, 8-hydro-quinoline, or their derivatives. In some embodiments, the composition of the present disclosure is used with other green-based organic inhibitors such as flavonoids, alkaloids, and by-products of plants. In certain other embodiments, the composition of the present disclosure is used with other green-based inorganic inhibitors such as lanthanide salts, chromates, or a combination thereof.

According to an aspect of the present disclosure, a corrosion inhibitor composition includes a fatty acid ethoxylate, a thiourea, an arylthiourea, a thiazole, and two or more solvents. In some embodiments, a metal article in contact with the composition has a corrosion rate in a range of about 25 to about 45 mils penetration per year (mpy), as determined by a high temperature/high pressure (HTHP) autoclave corrosion test according to the ASTM G111 standard test method (Standard Guide for Corrosion Tests in High Temperature or High Pressure Environment, or Both, ASTM G1111, which is incorporated herein by reference in its entirety). In some embodiments, the metal article in contact with the composition has a corrosion rate of about 28 to about 43 mpy, such as about 31 to about 41 mpy, about 34 to about 39 mpy, or about 35 to about 37 mpy, as determined by the ASTM G111 standard test method. In further embodiments, the metal article in contact with the composition has a corrosion rate of about 28 to about 43 mpy, as determined by the ASTM G111 standard test method. In further embodiments, the metal article in contact with the composition has a corrosion rate of about 31 to about 41 mpy, as determined by the ASTM G111 standard test method. In further embodiments, the metal article in contact with the composition has a corrosion rate of about 34 to about 39 mpy, as determined by the ASTM G111 standard test method. In further embodiments, the metal article in contact with the composition has a corrosion rate of 35 to 37 mpy, as determined by the ASTM G111 standard test method. In some embodiments, the fatty acid ethoxylate present in the corrosion inhibitor composition is a compound of formula (I)

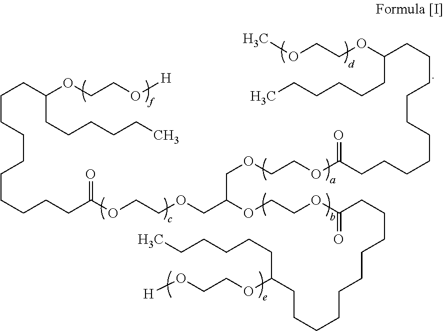

In some embodiments, each of a, b, c, d, e, and f is an integer of from 1 to 50, such as 1 to 30, 1 to 20, 2 to 15, 3 to 10, or 4 to 7. In some embodiments, 5<(a+b+c+d+e+f)<60, such as 10<(a+b+c+d+e+f) <50, or 20< (a+b+c+d+e+f)<40. In further embodiments, 5<(a+b+c+d+e+f)<60. In further embodiments, 10<(a+b+c+d+e+f)<50. In further embodiments, 20<(a+b+c+d+e+f)<40. In some embodiments, a+b+c+d+e+f=30.

In some embodiments, the fatty acid ethoxylate of formula (I) has an average molecular weight (Mw) of at least about 800 g/mol, such as at least about 1,000 g/mol, at least about 2,000 g/mol, at least about 3,000 g/mol, at least about 4,000 g/mol, or at least about 5,000 g/mol. In some embodiments, the fatty acid ethoxylate of formula (I) has an average molecular weight (Mw) of no more than about 40,000 g/mol, such as no more than about 20,000 g/mol, no more than about 10,000 g/mol, no more than about 6,000 g/mol, or no more than about 5,000 g/mol. Molecular weight determinations can be performed using GPC, using a cross-linked styrene-divinylbenzene column and calibrated to poly (ethylene oxide) references using a UV-VIS detector set at about 254 nanometers (nm). Samples can be prepared at a concentration of about 0.1 to about 2 milligram per milliliter (mg/mL), such as about 1 mg/mL, and eluted at a flow rate of about 0.1 to about 3 milliliter per minute (mL/min), such as about 1 mL/min.

In some embodiments, the fatty acid ethoxylate is present in the composition in an amount of about 0.5 to about 20 weight percentage (wt. %), such as about 3 to about 18 wt. %, about 5 to about 15 wt. %, about 8 to about 13 wt. %, or about 10 wt. % of the composition. In further embodiments, the fatty acid ethoxylate is present in the composition in an amount of about 1 to about 15 wt. % of the composition. In further embodiments, the fatty acid ethoxylate is present in the composition in an amount of about 10 wt. % of the composition. In some embodiments, the fatty acid ethoxylate of formula (I) is a natural oil ethoxylate. In further embodiments, the natural oil ethoxylate is present in the composition in an amount of about 0.5 to about 20 wt. %, such as about 3 to about 18 wt. %, about 5 to about 15 wt. %, about 8 to about 13 wt. %, or about 10 wt. % of the composition. In further embodiments, the natural oil ethoxylate is present in the composition in an amount of about 1 to about 15 wt. % of the composition. In further embodiments, the natural oil ethoxylate is present in the composition in an amount of about 10 wt. % of the composition.

In some embodiments, the thiourea present in the corrosion inhibitor composition is a compound of formula (II)

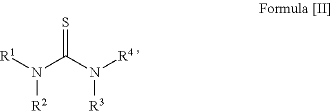

in which R¹, R², R³, and R⁴ are each independently selected from the group consisting of a hydrogen atom, a hydroxyl group, a halogen atom, an optionally substituted alkyl, and an optionally substituted cycloalkyl.

In some embodiments, R¹, R², R³, and R⁴ of formula (II) are each independently selected from the group consisting of a hydrogen, a hydroxyl, a chloride, and a methyl. In some embodiments, R¹, R², R³, and R⁴ are hydrogen atoms. In some embodiments, the thiourea is present in the composition in an amount of about 0.01 to about 10 wt. %, such as about 0.1 to about 8 wt. %, about 1 to about 5 wt. %, about 2 to about 3 wt. %, or about 2.5 wt. % of the composition. In further embodiments, the thiourea is present in the composition in an amount of about 0.1 to about 10 wt. % of the composition. In further embodiments, the thiourea is present in the composition in an amount of about 2.5 wt. % of the composition.

In some embodiments, the arylthiourea of the corrosion inhibitor composition is a compound of formula (III)

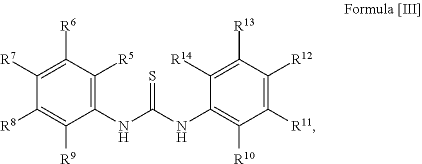

in which R⁵ to R¹⁴ are each independently selected from the group consisting of a hydrogen atom, a hydroxyl group, a halogen atom, an amine group, an optionally substituted alkyl, an optionally substituted alkoxy, and an optionally substituted alkoxyalkyl.

In some embodiments, R⁵ to R¹⁴ of formula (III) are each independently selected from the group consisting of a hydrogen, a hydroxyl, a chloride, and a methyl. In some embodiments, the arylthiourea is present in the composition in an amount of about 0.01 to about 10 wt. %, such as about 0.1 to about 8 wt. %, about 1 to about 5 wt. %, about 2 to about 3 wt. %, or about 2.5 wt. % of the composition. In further embodiments, the arylthiourea is present in the composition in an amount of about 0.1 to about 10 wt. % of the composition. In further embodiments, the arylthiourea is present in the composition in an amount of about 2.5 wt. % of the composition. In some embodiments, the arylthiourea is diphenyl thiourea. In some embodiments, the diphenyl thiourea is present in the composition in an amount of about 0.01 to about 10 wt. %, such as about 0.1 to about 8 wt. %, about 1 to about 5 wt. %, about 2 to about 3 wt. %, or about 2.5 wt. % of the composition. In some embodiments, the diphenyl thiourea is present in the composition in an amount of about 0.1 to about 10 wt. % of the composition. In further embodiments, the diphenyl thiourea is present in the composition in an amount of about 2.5 wt. % of the composition.

In some embodiments, the thiazole present in the composition is a compound of formula (IV)

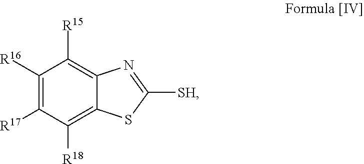

in which R¹⁵, R¹⁶, R¹⁷, and R¹⁸ are each independently selected from the group consisting of a hydrogen atom, a hydroxyl group, a halogen atom, an amine group, a cyano group, a nitro, a nitrile, an optionally substituted alkyl, and an optionally substituted alkoxy.

In some embodiments, R¹⁵, R¹⁶, R^{17,} and R¹⁸ of formula (IV) are each independently selected from the group consisting of a hydrogen, a hydroxyl, a chloride, and a methyl. In some embodiments, the thiazole is present in the composition in an amount of about 0.01 to about 10wt. %, such as about 0.1 to about 8 wt. %, about 1 to about 5 wt. %, about 2 to about 3 wt. %, or about 2.5 wt. % of the composition. In further embodiments, the thiazole is present in the composition in an amount of about 1 to about 5 wt. % of the composition. In further embodiments, the thiazole is present in the composition in an amount of about 2.5 wt. % of the composition. In some embodiments, the thiazole is benzo[d]thiazole-2-thiol. In some embodiments, the benzo[d]thiazole-2-thiol is present in the composition in an amount of about 0.01 to about 10 wt. %, such as about 0.1 to about 8 wt. %, about 1 to about 5 wt. %, about 2 to about 3 wt. %, or about 2.5 wt. % of the composition. In further embodiments, the benzo[d]thiazole-2-thiol is present in the composition in an amount of about 1 to about 5 wt. % of the composition. In further embodiments, the benzo[d]thiazole-2-thiol is present in the composition in an amount of about 2.5 wt. % of the composition.

In an embodiment, the corrosion inhibitor composition includes two or more solvents. In some embodiments, the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof.

In an embodiment, the corrosion inhibitor composition contains a glycol (e.g., polyglycol, propylene glycol, or ethylene glycol) and a polar protic solvent. In some embodiments, the polar protic solvent is water, acetone, acetonitrile, dimethylformamide (DMF), dimethyl sulfoxide (DMSO), isopropanol, methanol, or a combination thereof. In some embodiments, glycol enhances the water solubility or oil solubility of the thiourea, arylthiourea, and thiazole. The glycol does not participate in chemical reactions which prevent corrosion. In some embodiments, the polar protic solvent is present in the composition in an amount of about 20 to about 70 wt. %, such as about 25 to about 65 wt. %, about 30 to about 60 wt. %, about 35 to about 55 wt. %, about 40 to about 50 wt. %, or about 50 wt. % of the composition. In further embodiments, the polar protic solvent is present in the composition in an amount of about 30 to about 60 wt. % of the composition. In further embodiments, the polar protic solvent is present in the composition in an amount of about 45 wt. % of the composition. In some embodiments, the glycol is present in the composition in an amount of about 20 to about 70 wt. %, such as about 25 to about 65 wt. %, about 30 to about 60 wt. %, about 35 to about 55 wt. %, about 40 to about 50 wt. %, or about 50 wt. % of the composition. In further embodiments, the glycol is present in the composition in an amount of about 30 to about 60 wt. % of the composition. In further embodiments, the glycol is present in the composition in an amount of about 37.5 wt. % of the composition. In some embodiments, a ratio of the polar protic solvent to glycol present in the corrosion inhibitor composition is in a range of about 1:10 to about 10:1, such as about 1:8 to about 8:1, about 1:6 to about 6:1, about 1:4 to about 4:1, about 1:2 to about 2:1, or about 1:1. In further embodiments, a ratio of the polar protic solvent to glycol present in the corrosion inhibitor composition is about 6:5.

In some embodiments, the two or more solvents are DMSO and propylene glycol. In some embodiments, the DMSO is present in the composition in an amount of about 20 to about 70 wt. %, such as about 25 to about 65 wt. %, about 30 to about 60 wt. %, about 35 to about 55 wt. %, about 40 to about 50 wt. %, or about 50 wt. % of the composition. In further embodiments, the DMSO is present in the composition in an amount of about 30 to about 60 wt. % of the composition. In further embodiments, the DMSO is present in the composition in an amount of about 45 wt. % of the composition. In some embodiments, the propylene glycol is present in the composition in an amount of about 20 to about 70 wt. %, such as about 25 to about 65 wt. %, about 30 to about 60 wt. %, about 35 to about 55 wt. %, about 40 to about 50 wt. %, or about 50 wt. % of the composition. In further embodiments, the propylene glycol is present in the composition in an amount of about 30 to about 60 wt. % of the composition. In further embodiments, the propylene glycol is present in the composition in an amount of about 37.5 wt. % of the composition. In some embodiments, a ratio of the DMSO to propylene glycol present in the corrosion inhibitor composition is in a range of about 1:10 to about 10:1, such as about 1:8 to about 8:1, about 1:6 to about 6:1, about 1:4 to about 4:1, about 1:2 to about 2:1, or about 1:1. In further embodiments, a ratio of the DMSO to propylene glycol present in the corrosion inhibitor composition is about 6:5.

In some embodiments, the composition contains about 1 to about 15 wt. % of the natural oil ethoxylate, such as about 3 to about 12 wt. %, about 6 to about 10 wt. %, or about 10 wt. % of the natural oil ethoxylate; about 0.1 to about 10 wt. % of the thiourea, such as about 0.5 to about 8 wt. %, about 1 to about 5 wt. %, or about 2.5 wt. % of the thiourea; about 0.1 to about 10 wt. % of the diphenyl thiourea, such as about 0.5 to about 8 wt. %, about 1 to about 5 wt. %, or about 2.5 wt. % of the diphenyl thiourea; about 0.1 to about 10 wt. % of the benzo[d]thiazole-2-thiol, such as about 0.5 to about 8 wt. %, about 1 to about 5 wt. %, or about 2.5 wt. % of the benzo[d]thiazole-2-thiol; about 40 to 50 wt. % of the DMSO, such as about 42 to about 48 wt. %, about 44 to about 46 wt. %, or about 45 wt. % of the DMSO; and about 35 to 40 wt. % of the propylene glycol, such as about 36 to about 39 wt. %, about 37 to about 38 wt. %, or about 37.5 wt. % of the propylene glycol. In further embodiments, the composition contains about 10 wt. %

of the natural oil ethoxylate, about 2.5 wt. % of the thiourea, about 2.5 wt. % of the diphenyl thiourea, about 2.5 wt. % of the benzo[d]thiazole-2-thiol, about 45 wt. % of the DMSO, and about 37.5 wt. % of the propylene glycol.

In some embodiments, the corrosion inhibitor composition is used in conjunction with other suitable corrosion inhibitors known to one of ordinary skill in the art. In some embodiments, the corrosion inhibitor further comprises a secondary corrosion inhibitor. The secondary corrosion inhibitor may refer to any chemical compound or mixture thereof known by one of ordinary skill in the art to act as a corrosion inhibitor, particularly for inhibiting corrosion of steel and/or in CO₂-containing solutions. Such secondary corrosion inhibitors include, but are not limited to, quinolines, imidazolines, thioureas, pyridines and their various derivatives, alkenylphenones, amines, amides, acetylenic alcohols, quaternary salts, sulfoxides, thioethers, mercaptans, thiazoles, and thiocyanates.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The corrosion inhibitor composition described herein may be prepared using any suitable technique or combination of techniques known to one of ordinary skill in the art. In some embodiments, the components of the corrosion inhibitor composition are added to a single container. In such embodiments, the components are added in sequence. In alternative embodiments, the components are added simultaneously. In some embodiments, the two or more solvents are provided first, and other components are added to the solvent. In some embodiments, the corrosion inhibitor composition is prepared before being added to a corrosive fluid. In alternative embodiments, the corrosion inhibitor composition is prepared by addition of the components of the corrosion inhibitor composition to the corrosive fluid, e.g., downhole, and gas well. Such addition may be successive or simultaneous.

Also provided in the present disclosure is a method for inhibiting corrosion of a metal in contact with a corrosive fluid. The method includes adding a corrosive fluid the corrosion inhibitor composition in an amount of about 5 to about 15,000 ppm, such as about 10 to about 13,000 ppm, about 100 to about 10,000 ppm, about 200 to about 5,000 ppm, about 300 to about 2,500 ppm, about 400 to about 1,000 ppm, about 500 to about 800 ppm, or about 500 ppm, based on a total number of parts by weight of the corrosive fluid. In further embodiments, the method includes adding a corrosive fluid the corrosion inhibitor composition in an amount of about 500 ppm, based on a total number of parts by weight of the corrosive fluid.

In some embodiments, the adding the corrosive fluid to the corrosion inhibitor composition is performed at a temperature of about 70 to about 150° C., such as about 90 to about 140° C., about 100 to about 130° C., about 110 to about 120° C., or about 120° C. In further embodiments, the adding the corrosive fluid to the corrosion inhibitor composition is performed at a temperature of about 80 to about 120° C.

In some embodiments, the adding the corrosive fluid to the corrosion inhibitor composition is performed under a pressure of about 10 to about 200 psi, such as about 20 to about 180 psi, about 40 to about 160 psi, about 60 to about 140 psi, about 80 to about 120 psi, or about 100 psi. In further embodiments, the adding the corrosive fluid to the corrosion inhibitor composition is performed under a pressure of about 100 psi.

In some embodiments, the pressure is a partial pressure exerted by carbon dioxide (CO₂) molecules present in a gas mixture in contact with the corrosive fluid. In some embodiments, the corrosive fluid is an acid, alkali, base, or caustic solution, which corrodes elements such as metal. Examples of corrosive liquids are those that contain sulfuric acid, hydrofluoric acid, chromic acid, nitric acid, acetic acid, hydrochloric acid, or a combination thereof. In some embodiments, the corrosive fluid is an aqueous solution.

In an embodiment, the corrosive fluid includes carbon dioxide in an amount of at least 0.1 grams (g) carbon dioxide per kilogram (kg) of the corrosive fluid, such as at least about 0.5 g per kg of the corrosive fluid, at least about 1 g per kg of the corrosive fluid, at least about 5 g per kg of the corrosive fluid, at least about 10 g per kg of the corrosive fluid, at least about 25 g per kg of the corrosive fluid, at least about 50 g per kg of the corrosive fluid, at least about 100 g per kg of the corrosive fluid, at least about 150 g per kg of the corrosive fluid, or at least about 200 g per kg of the corrosive fluid.

In another embodiment, the alkali metal halide salt is present at a concentration of 0.001 to 200 grams per liter (g/L) based on a total volume of the corrosive fluid, such as about 1 to about 180 g/L, about 10 to about 160 g/L, about 30 to about 140 g/L, about 50 to about 120 g/L, about 70 to about 100 g/L, or about 90 g/L. In some embodiments, the alkali metal halide salt contains sodium chloride (NaCl), calcium chloride (CaCl₂), potassium chloride (KCl), magnesium chloride (MgCl₂), strontium chloride (SrCl₂), barium sulfate (BaSO₄), hydrates thereof, or mixtures thereof.

In some embodiments, NaCl is present in the corrosive fluid at a concentration of about 20 to about 80 g/L, such as about 25 to about 75 g/L, about 30 to about 70 g/L, about 35 to about 65 g/L, about 40 to about 60 g/L, about 45 to about 50 g/L, or about 46.7 g/L based on the total volume of corrosive fluid. In some embodiments, CaCl₂ is present in the corrosive fluid at a concentration of about 40 to about 100 g/L, such as about 45 to about 95 g/L, about 50 to about 90 g/L, about 55 to about 85 g/L, about 60 to about 80 g/L, about 65 to about 75 g/L, or about 70.4 g/L based on the total volume of corrosive fluid. In some embodiments, KCl is present in the corrosive fluid at a concentration of about 1 to about 10 g/L, such as about 2 to about 10 g/L, about 3 to about 10 g/L, about 4 to about 9 g/L, about 5 to about 8 g/L, about 6 to about 7 g/L, or about 6.6 g/L based on the total volume of corrosive fluid. In some embodiments, MgCl₂ is present in the corrosive fluid at a concentration of about 0.5 to about 9 g/L, such as about 1 to about 9 g/L, about 2 to about 8 g/L, about 3 to about 7 g/L, about 4 to about 6 g/L, about 4 to about 5 g/L, or about 4.38 g/L based on the total volume of corrosive fluid. In some embodiments, SrCl₂ is present in the corrosive fluid at a concentration of about 0.1 to about 8 g/L, such as about 0.5 to about 7 g/L, about 1 to about 6 g/L, about 2 to about 5 g/L, about 3 to about 5 g/L, about 3 to about 4 g/L, or about 3.95 g/L based on the total volume of corrosive fluid. In some embodiments, BaSO₄ is present in the corrosive fluid at a concentration of about 0.0001 to about 1 g/L, such as about 0.0005 to about 0.1 g/L, about 0.001 to about 0.05 g/L, about 0.0015 to about 0.01 g/L, about 0.0015 to about 0.005 g/L, about 0.0015 to about 0.003 g/L, or about 0.0019 g/L based on the total volume of corrosive fluid.

The corrosive fluid may optionally further include one or more additives. These additives may be purposefully added to modify the properties or functions of the corrosive fluid, as needed or be inadvertently incorporated into the corrosive fluid through contact between the corrosive fluid or constituents thereof with an additive or additive-containing fluid. Typically, when present, the additive(s) may be incorporated in an amount of less than about 10%, such as less than about 8%, less than about 6%, less than about 4%, less than about 2%, less than about 1%, less than about 0.5%, or less than about 0.1% by weight per total volume of the corrosive fluid.

Additive(s) suitable for use in oil and gas well operations are known by those of ordinary skill in the art, and include, but are not limited to, (i) viscosity modifying agents, e.g., bauxite, bentonite, dolomite, limestone, calcite, vaterite, aragonite, magnesite, taconite, gypsum, quartz, marble, hematite, limonite, magnetite, andesite, garnet, basalt, dacite, nesosilicates or orthosilicates, sorosilicates, cyclosilicates, inosilicates, phyllosilicates, tectosilicates, kaolins, montmorillonite, fullers earth, halloysite, polysaccharide gelling agents (e.g., xanthan gum, scleroglucan, and diutan) as well as synthetic polymer gelling agents (e.g., polyacrylamides and co-polymers thereof), psyllium husk powder, hydroxyethyl cellulose, carboxymethylcellulose, and polyanionic cellulose, poly (diallyl amine), diallyl ketone, diallyl amine, styryl sulfonate, vinyl lactam, laponite; (ii) chelating agents, such as chelating agents useful as sequesteration agents of metal ions, for example iron control agents, such as ethylene diamine tetraacetic acid (EDTA), diethylene triamine pentaacetic acid (DPTA), hydroxyethylene diamine triacetic acid (HEDTA), ethylene diamine di-ortho-hydroxy-phenyl acetic acid (EDDHA), ethylene diamine di-ortho-hydroxy-para-methyl phenyl acetic acid (EDDHMA), ethylene diamine di-ortho-hydroxy-para-carboxy-phenyl acetic acid (EDDCHA); (iii) stabilizing agents, e.g., polypropylene glycol, polyethylene glycol, carboxymethyl cellulose, hydroxyethyl cellulose, polysiloxane polyalkyl polyether copolymers, acrylic copolymers, alkali metal alginates and other water soluble alginates, carboxyvinyl polymers, polyvinylpyrollidones, polyacrylates; (iv) dispersing agents, e.g., polymeric or co-polymeric compounds of polyacrylic acid, polyacrylic acid/maleic acid copolymers, styrene/maleic anhydride copolymers, polymethacrylic acid and polyaspartic acid; (v) scale inhibitors, e.g., sodium hexametaphosphate, sodium tripolyphosphate, hydroxyethylidene diphosphonic acid, aminotris (methylenephosphonic acid (ATMP), vinyl sulfonic acid, allyl sulfonic acid, polycarboxylic acid polymers such as polymers containing 3-allyloxy-2-hydroxy-propionic acid monomers, sulfonated polymers such as vinyl monomers having a sulfonic acid group, polyacrylates and copolymers thereof; (vi) defoaming agents, e.g., silicone oils, silicone oil emulsions, organic defoamers, emulsions of organic defoamers, silicone-organic emulsions, silicone-glycol compounds, silicone/silica adducts, emulsions of silicone/silica adducts; (vii) emulsifiers, such as a tallow amine, a ditallow amine, or combinations thereof, for example a 50% concentration of a mixture of tallow alkyl amine acetates, C16-C18 (CAS 61790-60) and ditallow alkyl amine acetates (CAS 71011 Mar. 5) in a suitable solvent such as heavy aromatic naphtha and ethylene glycol; and (viii) surfactants, such as non-ionic surfactants as described herein, cationic surfactants, anionic surfactants, and amphoteric surfactants.

In some embodiments, the corrosive fluid is substantially free of additives (e.g., viscosity modifying agents, chelating agents, stabilizing agents, dispersing agents, scale inhibitors, defoaming agents, and surfactants).

In some embodiments, metals found in oil and gas fields that may be protected include, but are not limited to, carbon steels (e.g., mild steels, high-tensile steels, higher-carbon steels), chrome steels, ferritic alloy steels, austenitic stainless steels, precipitation-hardened stainless steels, high nickel content steels, galvanized steel, aluminum, aluminum alloys, copper, copper nickel alloys, copper zinc alloys, brass, ferritic alloy steels, and any combination thereof. Specific examples of typical oil field tubular steels include X60, J-55, N-80, L-80, P: 105, P110, and high alloy chrome steels such as Cr-9, Cr-13, Cr-2205, and Cr-2250. In some embodiments, the methods herein inhibit corrosion of a carbon steel. In some embodiments, the metal is a low carbon steel. In some embodiments, the low carbon steel is AISI 1018 carbon steel or API X-60 carbon steel.

The present disclosure also includes a method of protecting surfaces of objects formed from iron and steel. This can be achieved by applying the composition on the whole or at least a part of any metal surface susceptible to corrosion. The composition of the present disclosure can be used for treating metal surfaces such as metal pipes, casings, pumps, screens, valves, or any other fittings in oil, gas, and geothermal wells which are subjected to high temperatures and pressures and corrosive chemical agents, or for pipelines in which are transported fluids that contain water.

The metal surfaces, when treated with the corrosion inhibitor composition of the present discourse, demonstrate an inhibition efficiency of greater than about 90% when the metal is in contact with the corrosive fluid at about 25 to about 75° C. for about 10 to about 480 minutes by following the American Society for Testing and Materials (ASTM) G59 standard test method.

In some embodiments, when the composition is present in the corrosive fluid in an amount of about 500 ppm, the metal surfaces demonstrate an inhibition efficiency of about 80 to 95%, such as about 81 to about 92%, about 81 to about 90%, about 81 to about 87%, or about 82 to about 87%, when the metal is in contact with the corrosive fluid at a temperature of about 100 to about 150° C., such as about 110 to about 140° C., about 110 to about 130° C., or about 120° C. under a pressure of about 100 pounds per square inch (psi) by following the ASTM G111.

Corrosion rate is the speed at which metals undergo deterioration within a particular environment. The rate may depend on environmental conditions and the condition or type of metal. Factors often used to calculate or determine corrosion rate include, but are not limited to, weight loss (reduction in weight of the metal during reference time), area (initial surface area of the metal), time (length of exposure time) and density of the metal. Corrosion rate may also be computed using mils penetration per year (mpy).

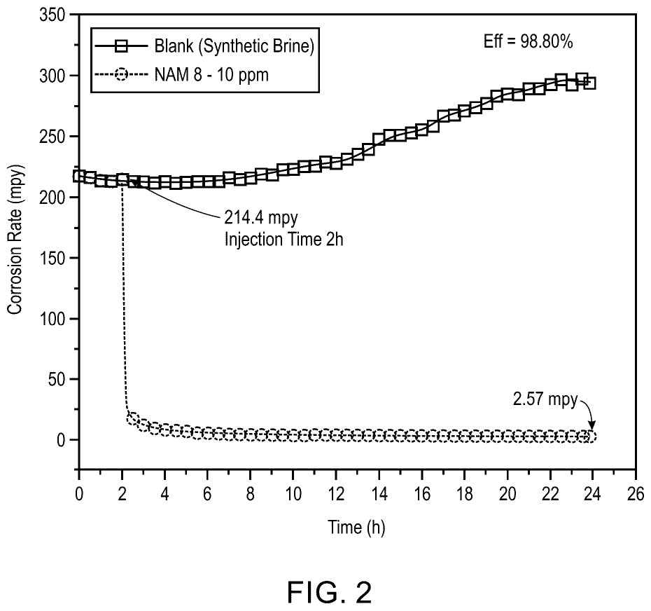

In some embodiments, corrosion rate is measured by a bubble test according to the ASTM G59 and G3 standard test methods (Standard Test Method for Conducting Potentiodynamic Polarization Resistance Measurements, ASTM G59-97 (2020); and Standard Practice for Conventions Applicable to Electrochemical Measurements in Corrosion Testing, ASTM G3-14 (2019), each of which is incorporated herein by reference in their entireties). In some embodiments, a carbon steel (C1018) sample is cleaned before exposure to the corrosive fluid according to the ASTM G1 (Standard Practice for Preparing, Cleaning, and Evaluating Corrosion Test Specimens, ASTM G1-03 (2017), which is incorporated herein by reference in its entirety). In some embodiments, the corrosive fluid used in the bubble test contains saturated carbon dioxide, alkali metal halide salts, and about 10 ppm of the corrosion inhibitor composition. In some embodiments, the bubble test is performed by exposing the metal sample to the corrosive fluid at a temperature of about 60 to about 80° C., such as about 65 to about 75° C., or about 70° C. for about 12 to about 48 hours, or about 12 to 36 hours, or about 24 hours. In some embodiments, the method of the present disclosure provides a corrosion rate of about 1 to about 6 mpy, such as about 1.5 to about 5 mpy, about 2 to about 4 mpy, about 2.5 to about 3 mpy measured by the bubble test according to the ASTM G59 and G3, as depicted in FIG. 2.

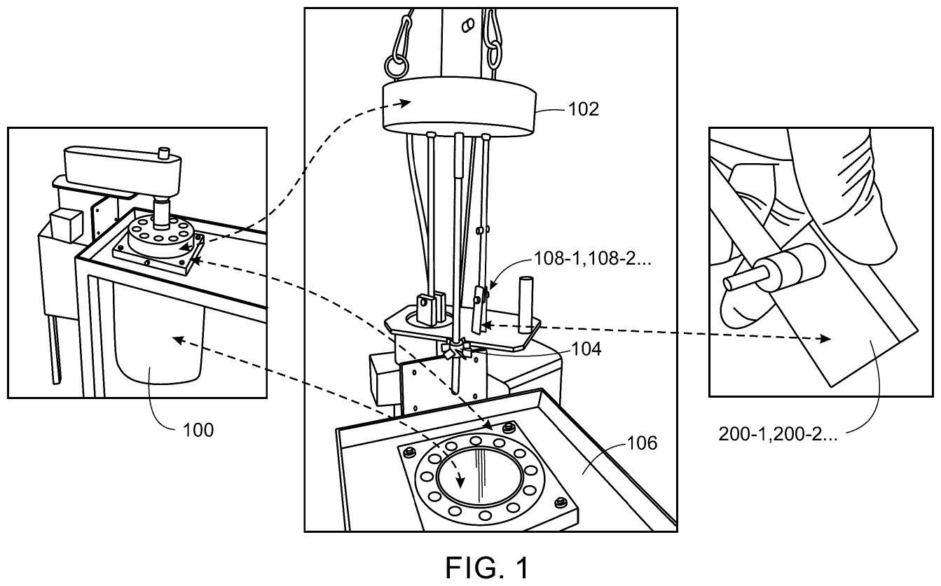

In some embodiments, corrosion rate is further measured by a high temperature high pressure (HTHP) dynamic autoclave test according to the ASTM G111. FIG. 1 is a diagrammatic illustration depicting setup of a stirred autoclave used for the HTHP autoclave corrosion test. In some embodiments, the stirred autoclave 100 contains a head unit 102, a stirrer 104, a reaction chamber 106, and a plurality of fixed samples (108-1, 108-2 . . . ). In some embodiments, the head unit 102 includes a pressure control unit to monitor and control the pressure inside the reaction chamber 106, a temperature control unit to monitor and control the temperature inside the reaction chamber 106, and a stirring mechanism operatively connected to the stirrer 104. In some embodiments, a first end of the fixed sample 108-1 is operatively connected to the head unit 102. In some embodiments, two metal coupons 200-1 (not shown) and 200-2 having the same size are disposed on a second end of the fixed sample 108-1 and are positioned opposite each other with respect to the longitudinal axis of the fixed sample 108-1. Prior to the HTHP autoclave test, the two metal coupons 200-1 (not shown) and 200-2 are cleaned according to the ASTM G1. In some embodiments, the two metal coupons (200-1 and 200-2) are made from carbon steel (e.g., C1018 steel). The two metal coupons (200-1 and 200-2), after the cleaning, are immersed in the corrosive fluid containing saturated carbon dioxide, alkali metal halide salts, and about 500 ppm of the corrosion inhibitor composition for about 1 to about 48 hours, such as about 2 to about 24 hours, or about 4 to about 12 hours. After the immersing, the two metal coupons (200-1 and 200-2) are positioned and installed on the second end of the fixed sample 108-1. In some embodiments, the stirrer 104 and the plurality of fixed samples (108-1, 108-2 . . . ) are enclosed in a sealed space formed by the head unit 102 and the reaction chamber 106. In some embodiments, the HTHP autoclave corrosion test is performed under a CO₂ partial pressure of about 100 psi and at a temperature of about 120° C. for about 24 hours. In some embodiments, the stirrer 104 is operated at a mixing speed of about 500 revolutions per minute (rpm). In some embodiments, the method of the present disclosure provides a corrosion rate of about 25 to about 45 mpy, such as about 28 to about 42 mpy, about 31 to about 39 mpy, or about 36.9 mpy measured by the HTHP autoclave corrosion test according to ASTM G111.

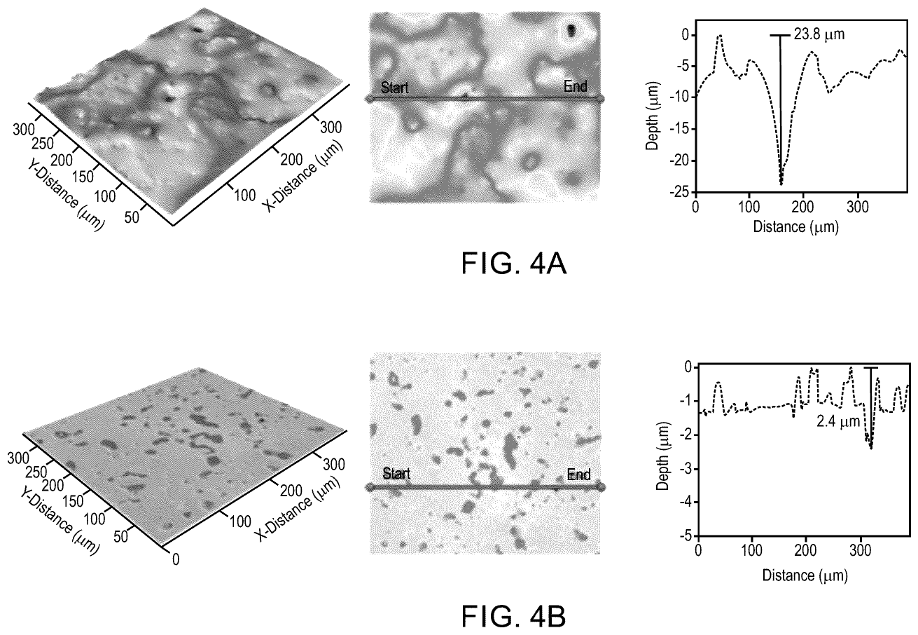

FIGS. 4A and 4B demonstrate the surface and depth profile of the metal coupons obtained after the HTHP autoclave corrosion test in the absence and presence of the corrosion inhibitor composition, respectively. In some embodiments, images and depth profile of the metal coupons are collected on a 3D optical profilometer (Profilm 3D, Germany).

In some embodiments, the metal coupon after the HTHP autoclave corrosion test in the absence of the corrosion inhibitor composition has a rough surface comprising a plurality of peaks (e.g., deposits of various alkali metal halide salts) and valleys (e.g., pits). In some embodiments, a maximum depth of pits present on surfaces of the metal coupon is in a range of about 15 to about 40 micrometers (μm), such as about 18 to about 35 μm, about 21 to about 30 μm, about 22 to about 25 μm, or about 23.8 μm, as depicted in FIG. 4A.

In some embodiments, the metal coupon after the HTHP autoclave corrosion test in the presence of the corrosion inhibitor composition has a smooth surface. In some embodiments, a maximum depth of pits present on surfaces of the metal coupon is in a range of about 0.5 to about 5 μm, such as about 1 to about 4 μm, about 1.5 to about 3 μm, about 2 to about 2.5 μm, or about 2.4 μm, as depicted in FIG. 4B.

In some embodiments, the metal surfaces are protected by dipping or spraying the surfaces with the compositions of the present disclosure and then allowing excess fluid to drain from the treated surfaces under ambient conditions. A protective film is thus formed on the metal surface without conventional heat-curing or extended air-drying treatment. However, such drying treatments can be used if desired and if conditions permit it. The advantage of using an anti-corrosion system that does not require air-or heat-drying is that the system can be applied to metal surfaces that are hundreds or thousands of feet below ground level or in an environment that is constantly flooded with brine or other fluids. In some embodiments, a protective film is formed on the metal surface after subjecting the metal surface to heat treatments upon application of the composition.

When applying the composition to the metal tubing of, for example, a gas or oil well or a pipeline, it is not necessary to pre-coat the treated metal surfaces with oil or other substances before applying the composition of the present disclosure. The treated surfaces may or may not have an oil coating before the application. Illustrative examples of which include, but are not limited to, separation vessels, dehydration units, gas lines, pipelines, cooling water systems, valves, spools, fittings (e.g., such as those that make up the well Christmas tree), treating tanks, storage tanks, coils of heat exchangers, fractionating columns, cracking units, pump parts (e.g., parts of beam pumps), and in particular downhole surfaces that are most likely to come into contact with the corrosive fluid during stimulation operations, matrix acidizing operations, and/or carbon dioxide flooding operations, such as those casings, liners, pipes, bars, pump parts such as sucker rods, electrical submersible pumps, screens, valves, fittings, and the like.

### EXAMPLES

The following examples demonstrate methods of preventing/reducing/inhibiting corrosion of a metal surface from a corrosive fluid using a corrosion inhibitor composition, as described herein. The examples are provided solely for illustration and are not to be construed as limitations of the present disclosure, as many variations thereof are possible without departing from the spirit and scope of the present disclosure.

### Example 1

### Preparation of a Corrosion Inhibitor Composition

A corrosion inhibitor composition (NAM8) was prepared according to Table 1. The composition was stirred until a homogeneous mixture was achieved. The composition can be prepared using any known agitation method known to those of ordinary skill in the art, for example, via stirring, swirling, mixing, sonicating (e.g., ultrasonication or sonication) for any amount of time needed to achieve the homogeneous mixture.

TABLE 1
Corrosion inhibitor composition (NAM 8).

| Corrosion inhibitor composition | Weight % |
|---|---|
| Natural oil ethoxylate | 10 |
| Thiourea | 2.5 |
| Diphenyl thiourea | 2.5 |
| Azole | 2.5 |
| DMSO | 45 |
| Glycol | 37.5 |

### Example 2

### Corrosion Bubble Test

The performance of the corrosion inhibitor compositions was conducted using a cylindrical carbon steel (C1018) supplied by Gamry, USA. A carbon steel coupon was grinded with #400, #600, and #800 grit size silicon carbide paper, washed thoroughly with distilled water, degreased with acetone, and dried with air. The grinded carbon steel coupon was used for corrosion testing. A standard 1000L corrosion cell was used. The Gamry Reference 1010E Potentiostat/Galvanostat and Echem Analyst software suite for data analysis were utilized for the electrochemical measurements. For this test, five ports arrangements consisting of cylindrical C1018 carbon steel coupon as the working electrode, the saturated calomel electrode (SCE) as the reference electrode, a cylindrical graphite rod as the counter electrode were employed, a CO₂ gas sparger and a final port to hold pH and temperature meter.

In the bubble test, the corrosion inhibitor composition was tested according to the ASTM G59 and G3 ASTM standards. A carbon steel (C1018) coupon was used for corrosion testing. The test was carried out at about 70° C., in formation water brine (Table 2). CO₂ gas was bubbled into the brine to de-aerate the solution for the first two hours and was continuously bubbled throughout the test to simulate sweet corrosive condition. The solution was continuously stirred at a rotation speed of about 500 rpm throughout the test using a magnetic stirrer. After about 2 hours of purging CO₂ gas, the corrosion system was monitored for about 1 hour to ensure a stable open circuit potential (OCP) was obtained. Then the corrosion rate using linear polarization resistance (LPR) was initiated and the corrosion rate recorded automatically every 10 minutes. A pre-corrosion of about 2 hours of the carbon steel coupon (exposed area of about 5.23 cm²) was allowed before injection of the corrosion inhibitor composition. A concentration of 10 ppm of the corrosion inhibitor composition was used to evaluate its performance in inhibiting corrosion. The test conditions are provided in Table 3. The test was then monitored for a duration of 24 hours to allow the corrosion rate to equilibrate. The performance of the corrosion inhibitor compositions was then calculated as percent corrosion protection (E_{ff}) with respect to the uninhibited baseline corrosion rate (CR_{pc}) and the inhibited corrosion rate (CRᵢₕ) during the 2-hour pre-corrosion period before the addition of the corrosion inhibitor composition, as depicted in Equation. 1.

$$\% Corrosion Protection ( Eff ) = \frac{C {R}_{p c} - C {R}_{i h}}{C {R}_{p c}} \times 100 \% \qquad ( 1 )$$

Where CR_{pc} is the corrosion rate before injection of inhibitor, and CRᵢₕ is the stabilized corrosion rate after the addition of the corrosion inhibitors.

TABLE 2
Composition of the formation water brine.

| Salt | Amount (g/L) |
|---|---|
| NaCl | 46.7 |
| CaCl₂•2H₂O | 70.4 |
| KCl | 6.6 |
| MgCl₂•6H₂O | 4.38 |
| SrCl₂•6H₂O | 3.95 |
| BaSO₄ | 0.0019 |

TABLE 3
Corrosion bubble test conditions.

| Condition | Value |
|---|---|
| Temperature (° C.) | 70 ± 1 |
| CO₂ | Saturated |
| Stir Rate (rpm) | 500 |
| Water cut (%)/Working pH | 100/3.7 ± 0.1 |
| Total fluid volume (mL) | 1000 |
| Brine | Formation water brine |
| Specimen | C1018 |
| Test duration (hour) | 24 (2 h pre-corrosion) |
| Inhibitor concentration (ppm) | 10 |
| Electrochemical technique | Linear Polarization Resistance (LPR) |
| Corrosion inhibitor | NAM 8 |

### Example 3

### High Temperature/High Pressure Dynamic Autoclave Test (Weight Loss)

The autoclave test was performed to examine the performance of the corrosion inhibitor composition (NAM 8) at high-temperature, high-pressure, and high-shear stress. A pre-weighed carbon steel (C1018) coupon was suspended on the head of the autoclave and immersed in a 2.5 L solution of formation water brine (Table 2) test solution. The brine was de-aerated with nitrogen gas for 3 hours. The autoclave was then sealed, de-aerated with nitrogen gas for another 1 hour and then pressurized to a pressure of 100 pounds per square inch (psi) with CO₂ and heated to about 120° C. A flow speed of about 500 rpm was employed to induce shear stress and the coupons were exposed for 24 hours. The parameters used for the HTHP weight loss test are provided in

Table 4 and the experimental set-up is shown in FIG. 1. A corrosion inhibitor concentration of 500 ppm was used to examine the corrosion protective performance of the corrosion inhibitor compositions under these conditions. After 24 hours, the coupons were removed, cleaned with the Super Clark's solution (5 g/L of N, N-dibutylthiourea dissolved in 18% HCl), reweighed and the corrosion rate was calculated according to Equation. 2 (ASTM standard: Designation G 1).

$$Corrosion rate ( mm / year ) = ( W \times 876 \; 00 ) / ( A \times T \times D ) \qquad ( 2 )$$

where W is the weight loss in g, A is the surface area exposed in cm², T is the time of exposure in hours, and D is the density in g/cm³ (e.g., about 7.86g/cm³ for carbon steel).

TABLE 4
HTHP dynamic autoclave weight loss test conditions.

| Conditions | Parameters |
|---|---|
| Temperature (° C.) | 120 |
| Material | C1018 carbon steel |
| Brine (100% water cut) | Formation water |
| | Brine (Table 2) |
| De-aerated of test solution with N₂ (hours) | 3 |
| Purging in autoclave with N₂ (hour) | 1 |
| CO₂ Partial Pressure (psi) | 100 |
| Test duration (hours) | 24 |
| Flow speed (rpm) | 500 |
| Corrosion Inhibitor concentration | 500 ppm |
| Solution Volume (L) | 2.5 |

### Example 4

### Corrosion Bubble Test Results

The bubble test result of the corrosion inhibitor composition (NAM 8) was examined using a C1018 carbon steel coupon at about 70° C. after a 2-hour pre-corrosion in a brine solution (synthetic brine) as shown in Table 2. The test was conducted at a concentration of 10 ppm of the corrosion inhibitor composition. The linear polarization resistance (LPR) curves showing the corrosion inhibition performance of NAM8 for C1018 carbon steel in a simulated formation water brine (synthetic brine) saturated with CO₂ after a 2-hour pre-corrosion is provided in FIG. 2. Referring to FIG. 2, the corrosion rate in the absence of the corrosion inhibitor composition (blank), was about 214.4 mpy. The addition of the corrosion inhibitor composition at a concentration of about 10 ppm into the formation water brine after a pre-corrosion of 2-hour may reduce the corrosion rates from about 214.4 mpy to about 2.57 mpy. Additionally, the inhibition efficiency reached 98.80% indicating that NAM 8 shows an enhanced corrosion inhibition performance on carbon steel.

### Example 5

### HTHP Dynamic Autoclave Weight Loss Test Results

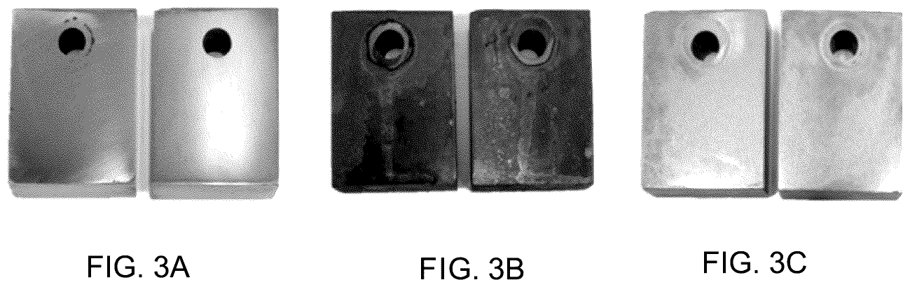

Table 5 shows the corrosion rates and the corresponding corrosion inhibition efficiency. The determination of the weight loss using the HTHP autoclave test was conducted for about 24 hours. The corrosion rate of the blank is about 250.6 mpy. For the inhibited active sample obtained from the corrosion inhibitor composition NAM 8, the corrosion rate dropped to about 36.9 mpy. The corresponding corrosion protective efficiency was about 85.3%. The corrosion inhibitor compositions reduced the corrosion rate of steel by more than 10 times at a concentration of 500 ppm under the above-described conditions in Table 4 (i.e., at a temperature of 120° C., a pressure of 100 psi, and a flow speed of 500 rpm). FIG. 3A shows the images of C1018 coupons before corrosion exposure. FIG. 3B shows the images of C1018 coupons after corrosion exposure. FIG. 3C shows the images of C1018 coupons after cleaning obtained from the corrosive formation water brine under the test conditions depicted in Table 4. Referring to FIGS. 3A and 3C, the coupons exhibited substantial similarity in surface morphology without pitting and cavities before exposure and after cleaning, indicating the protection afforded by the corrosion inhibitor compositions of the present disclosure.

### Example 6

### Surface Characterization

Post immersion surface characterization was conducted on carbon steel coupons after immersion in autoclave for 24 hours at 120° C. in the CO₂-saturated water brine (synthetic brine, Table 2) solution with and without the corrosion inhibitor composition, respectively. The surface profile of the carbon steel coupons was characterized on a 3D optical profilometer (Profilm 3D, Germany) to examine the pit depth. FIGS. 4A and 4B show 2D and 3D optical images of C1018 steel coupons. FIG. 4A shows the surface and depth profile of the C1018 steel coupon obtained after the HTHP autoclave corrosion test in the absence of the corrosion inhibitor composition, indicating deposits of alkali metal salts on surfaces of the C1018 steel coupon. Additionally, pits with a maximum depth of about 23.8 μm were observed on the surfaces of the C1018 steel coupon, as depicted in FIG. 4A. FIG. 4B shows a surface and a depth profile of the C1018 steel coupon obtained after the HTHP autoclave corrosion test in the presence of the corrosion inhibitor composition at a concentration of about 500 ppm. With the addition of the corrosion inhibitor composition, the maximum pit depth dropped to 2.4 μm, as depicted in FIG. 4B. This reduction in the pit depth may be attributed to the presence of the corrosion inhibitor composition in the form of a protective film deposited on the metal surface. The corrosion inhibitor composition of the present disclosure demonstrates enhanced efficacy in mitigating the corrosive effects, resulting in shallower pits and improved durability of the material.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### EMBODIMENTS

Embodiment 1: A corrosion inhibitor composition, comprising a fatty acid ethoxylate, a thiourea, an arylthiourea, a thiazole and two or more solvents.
Embodiment 2: The composition of embodiment 1, wherein the fatty acid ethoxylate is a compound of formula (I)

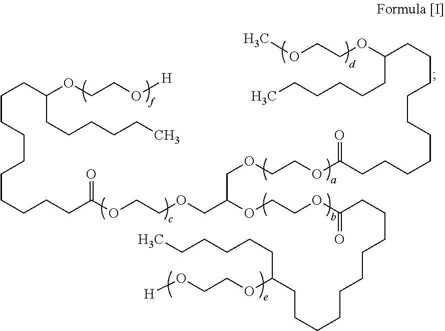

wherein each of a, b, c, d, e, and f is an integer of from 1 to 20.
Embodiment 3: The composition of embodiments 1 or 2, wherein 5<a+b+c+d+e+f<60.
Embodiment 4: The composition of any one of embodiments 1-3, wherein the fatty acid ethoxylate is present in the composition in an amount of 0.5 to 20 wt. % of the composition.
Embodiment 5: The composition of any one of embodiments 1-4, wherein the thiourea is a compound of formula (II)

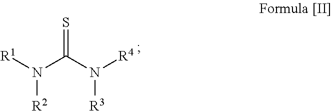

wherein R¹, R², R³, and R⁴ are each independently selected from the group consisting of a hydrogen atom, a halogen atom, a hydroxyl group, an optionally substituted alkyl, and an optionally substituted cycloalkyl.
Embodiment 6: The composition of any one of embodiments 1-5, wherein the thiourea is present in the composition in an amount of about 0.01 to about 10 wt. % of the composition.
Embodiment 7: The composition of any one of embodiments 1-6, wherein the arylthiourea is a compound of formula (III)

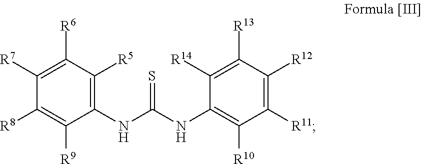

wherein R⁵ to R¹⁴ are each independently selected from the group consisting of a hydrogen atom, a halogen atom, a hydroxyl group, an amine group, an optionally substituted alkyl, an optionally substituted alkoxy, and an optionally substituted alkoxyalkyl.
Embodiment 8: The composition of any one of embodiments 1-7, wherein the arylthiourea is present in the composition in an amount of about 0.01 to about 10 wt. % of the composition.
Embodiment 9: The composition of any one of embodiments 1-8, wherein the thiazole is a compound of formula (IV)

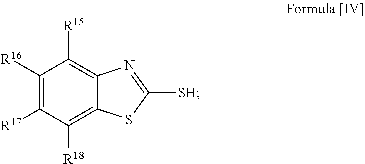

wherein R¹⁵, R¹⁶, R¹⁷, and R¹⁸ are each independently selected from the group consisting of a hydrogen atom, a halogen atom, a hydroxyl group, an amine group, a cyano group, a nitro, a nitrile, an optionally substituted alkyl, and an optionally substituted alkoxy.
Embodiment 10: The composition of any one of embodiments 1-9, wherein the thiazole is present in the composition in an amount of about 0.1 to about 10 wt. % of the composition.
Embodiment 11: The composition of any one of embodiments 1-10, wherein the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof.
Embodiment 12: The composition of any one of embodiments 1-11, wherein the two or more solvents comprise dimethyl sulfoxide (DMSO) and glycol.
Embodiment 13: The composition of any one of embodiments 1-12, wherein the DMSO is present in the composition in an amount of about 20 to about 70 wt. % of the composition; and the glycol is present in the composition in an amount of about 20 to about 70 wt. % of the composition.
Embodiment 14: The composition of any one of embodiments 1-13, comprising about 1 to 15 wt. % of the natural oil ethoxylate, about 0.1 to 10 wt. % of the thiourea, about 0.1 to 10 wt. % of the diphenyl thiourea, about 0.1 to 10 wt. % of the benzo[d]thiazole-2-thiol, about 40 to 50 wt. % of the DMSO, and about 30 to 60 wt. % of the glycol.
Embodiment 15: The composition of any one of any one of embodiments 1-14, wherein a metal article in contact with the corrosion inhibitor composition has a corrosion rate in a range of about 25 to about 45 mils per year (mpy), as determined by an ASTM G111 standard test method.
Embodiment 16: A method for inhibiting corrosion of a metal in contact with a corrosive fluid, the method comprising adding to the corrosive fluid the composition of embodiment 1 in an amount of about 5 to about 15,000 ppm based on a total number of parts by weight of the corrosive fluid at a temperature of about 70 to about 150 degrees Celsius (° C.).
Embodiment 17: The method of embodiment 16, wherein the corrosive fluid comprises carbon dioxide in an amount of at least 0.1 grams (g) carbon dioxide per kilogram (kg) of the corrosive fluid.
Embodiment 18: The method of embodiments 16 or 17, wherein the corrosive fluid comprises an alkali metal halide salt, and wherein the alkali metal halide salt comprises sodium chloride, calcium chloride dihydrate, potassium chloride, magnesium chloride hexahydrate, strontium chloride hexahydrate, barium sulfate, hydrates thereof, or mixtures thereof.
Embodiment 19: The method of any one of embodiments 16-18, wherein the metal is a steel, and wherein the steel is a carbon steel.
Embodiment 20: The method of any one of embodiments 16-19, wherein the composition is present in the corrosive fluid in an amount of about 500 ppm, and wherein the method has an inhibition efficiency of about 80 to about 95% when the metal is in contact with the corrosive fluid at a temperature of about 120° C. under a pressure of about 100 pounds per square inch (psi) by following the ASTM G111 and ASTM G59 standard test methods.

1. A corrosion inhibitor composition, comprising:
a fatty acid ethoxylate;
a thiourea;
an arylthiourea;
a thiazole; and
two or more solvents.

2. The composition of claim 1, wherein the fatty acid ethoxylate is a compound of formula (I) 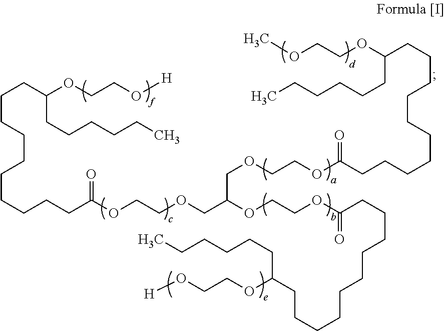
wherein each of a, b, c, d, e, and f is an integer of from 1 to 20.

3. The composition of claim 2, wherein 5<a+b+c+d+e+f<60.

4. The composition of claim 1, wherein the fatty acid ethoxylate is present in the composition in an amount of 0.5 to 20 wt. % of the composition.

5. The composition of claim 1, wherein the thiourea is a compound of formula (II) 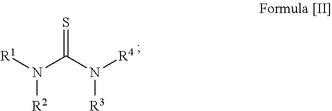
wherein R¹, R², R³, and R⁴ are each independently selected from the group consisting of a hydrogen atom, a halogen atom, a hydroxyl group, an optionally substituted alkyl, and an optionally substituted cycloalkyl.

6. The composition of claim 1, wherein the thiourea is present in the composition in an amount of about 0.01 to about 10 wt. % of the composition.

7. The composition of claim 1, wherein the arylthiourea is a compound of formula (III) 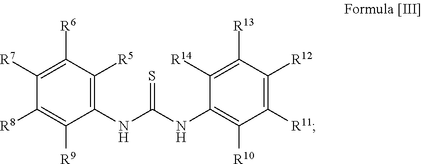
wherein R⁵ to R¹⁴ are each independently selected from the group consisting of a hydrogen atom, a halogen atom, a hydroxyl group, an amine group, an optionally substituted alkyl, an optionally substituted alkoxy, and an optionally substituted alkoxyalkyl.

8. The composition of claim 1, wherein the arylthiourea is present in the composition in an amount of about 0.01 to about 10 wt. % of the composition.

9. The composition of claim 1, wherein the thiazole is a compound of formula (IV) 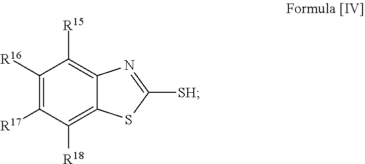
wherein R¹⁵, R¹⁶, R¹⁷, and R¹⁸ are each independently selected from the group consisting of a hydrogen atom, a halogen atom, a hydroxyl group, an amine group, a cyano group, a nitro, a nitrile, an optionally substituted alkyl, and an optionally substituted alkoxy.

10. The composition of claim 1, wherein the thiazole is present in the composition in an amount of about 0.1 to about 10 wt. % of the composition.

11. The composition of claim 1, wherein the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof.

12. The composition of claim 11, wherein the two or more solvents comprise dimethyl sulfoxide (DMSO) and glycol.

13. The composition of claim 12, wherein:
the DMSO is present in the composition in an amount of about 20 to about 70 wt. % of the composition; and
the glycol is present in the composition in an amount of about 20 to about 70 wt. % of the composition.

14. The composition of claim 1, comprising:
about 1 to 15 wt. % of the natural oil ethoxylate;
about 0.1 to 10 wt. % of the thiourea;
about 0.1 to 10 wt. % of the diphenyl thiourea;
about 0.1 to 10 wt. % of the benzo[d]thiazole-2-thiol;
about 40 to 50 wt. % of the DMSO; and
about 30 to 60 wt. % of the glycol.

15. The composition of claim 1, wherein a metal article in contact with the corrosion inhibitor composition has a corrosion rate in a range of about 25 to about 45 mils per year (mpy), as determined by an ASTM G111 standard test method.

16. A method for inhibiting corrosion of a metal in contact with a corrosive fluid, the method comprising:
adding to the corrosive fluid the composition of claim 1 in an amount of about 5 to about 15,000 ppm based on a total number of parts by weight of the corrosive fluid at a temperature of about 70 to about 150 degrees Celsius (° C.).

17. The method of claim 16, wherein the corrosive fluid comprises carbon dioxide in an amount of at least 0.1 grams (g) carbon dioxide per kilogram (kg) of the corrosive fluid.

18. The method of claim 16, wherein the corrosive fluid comprises an alkali metal halide salt, and wherein the alkali metal halide salt comprises sodium chloride, calcium chloride dihydrate, potassium chloride, magnesium chloride hexahydrate, strontium chloride hexahydrate, barium sulfate, hydrates thereof, or mixtures thereof.

19. The method of claim 16, wherein the metal is a steel, and wherein the steel is a carbon steel.

20. The method of claim 16, wherein the composition is present in the corrosive fluid in an amount of about 500 ppm, and wherein the method has an inhibition efficiency of about 80 to about 95% when the metal is in contact with the corrosive fluid at a temperature of about 120° C. under a pressure of about 100 pounds per square inch (psi) by following the ASTM G111 and ASTM G59 standard test methods.
